(19) United States
(12) Patent Application Publication
(10) Pub. No.: US 2024/0323810 A1
(43) Pub. Date: Sep. 26, 2024

(54) COMPENSATED MESH NETWORKING THROUGH INTERNET-OF-THINGS (IOT) EXTENSION

(71) Applicant: International Business Machines Corporation, Armonk, NY (US)

(72) Inventors: Brian P. Carey, Raleigh, NC (US); Zachary A. Silverstein, Georgetown, TX (US)

(21) Appl. No.: 18/187,872

(22) Filed: Mar. 22, 2023

(51) Int. Cl. H04W 48/10; H04W 48/02

(52) U.S. Cl. CPC H04W 48/10; H04W 48/02; H04W 84/18

(57) ABSTRACT

According to one embodiment, a method, computer system, and computer program product for extending a wireless network is provided. The embodiment may include receiving an opt-in from a user to re-broadcast a signal of the wireless network via an internet-of-things (IoT) device of the user. The embodiment may include receiving contextual and technical attributes of the IoT device. The embodiment may include identifying metadata of the wireless network. Responsive to determining, based on analysis of the received contextual and technical attributes and the identified metadata, that use of the IoT device to re-broadcast the signal is beneficial to the wireless network, the embodiment may include re-broadcasting the signal via the IoT device and granting access to the wireless network via the IoT device.

### BACKGROUND

The present invention relates generally to the field of computing, and more particularly to wireless network communication.

A wireless network is a computer network that uses wireless data connections between network nodes, thus enabling the transmission of information (i.e., data) over a distance without the use of wires or cables. The network nodes may be a variety of electronic devices that are connected to a wireless network and capable of creating, receiving, or transmitting information over a communication channel. Wireless networks are generally realized and administrated using radio frequency (RF) communication implemented at the physical layer of the Open Systems Interconnection (OSI) model. Examples of wireless networks include a wireless personal area network (WPAN), a wireless local area network (WLAN), a wireless ad hoc network (i.e., a mesh network), a wireless metropolitan area network (WMAN), a wireless wide area network (WWAN), and a cellular network.

### SUMMARY

According to one embodiment, a method, computer system, and computer program product for extending a wireless network is provided. The embodiment may include receiving an opt-in from a user to re-broadcast a signal of the wireless network via an internet-of-things (IoT) device of the user. The embodiment may include receiving contextual and technical attributes of the IoT device. The embodiment may include identifying metadata of the wireless network. Responsive to determining, based on analysis of the received contextual and technical attributes and the identified metadata, that use of the IoT device to re-broadcast the signal is beneficial to the wireless network, the embodiment may include re-broadcasting the signal via the IoT device and granting access to the wireless network via the IoT device.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary computer environment according to at least one embodiment.

FIG. 2 illustrates an operational flowchart for allowing access, via a mobile device, to a wireless network in exchange for wireless network signal re-broadcast by the mobile device via a mesh network extension access process, according to at least one embodiment.

FIG. 3 illustrates an operational flowchart for compensating a user in exchange for wireless network signal re-broadcast by their mobile device via a mesh network extension compensation process, according to at least one embodiment.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

The present invention relates generally to the field of computing, and more particularly to wireless network communication. The following described exemplary embodiments provide a system, method, and program product to, among other things, allow a mobile computing device to join a network, that would benefit from range extension, by providing network signal repeater capability of the mobile computing device in exchange for network access. Therefore, the present embodiment has the capacity to improve the technical field of wireless network communication by dynamically utilizing wireless network signal repeater functionality of one or more mobile devices in exchange for access to a wireless network, thus increasing signal repetition of the wireless network and extending a coverage range of the wireless network.

As previously described, a wireless network is a computer network that uses wireless data connections between network nodes, thus enabling the transmission of information (i.e., data) over a distance without the use of wires or cables. The network nodes may be a variety of electronic devices that are connected to a wireless network and capable of creating, receiving, or transmitting information over a communication channel. Wireless networks are generally realized and administrated using RF communication implemented at the physical layer of the OSI model. Examples of wireless networks include a WPAN, a WLAN, a WMAN, a WWAN, a cellular network, and a wireless mesh network (WMN). A WMN is any wireless network where data is transmitted using mesh networking. That is, where nodes (e.g., peer radio devices such as Internet-of-Things (IoT) devices) of the network don't just send and receive data, but also collaborate in propagating data on the network; thereby increasing range of the network. As such, a WMN may be thought of as a collection of nodes where each node is also a router.

Although wireless networks offer users convenience and mobility, often times such networks deal with range issues of their wireless setup and router capacity. For example, a typical range of a common Wi-Fi network with standard equipment is on the order of tens of meters. While such range may be sufficient for a typical home, it may be lacking for a larger structure or area where wireless network users are more spread out. Measures may be taken to obtain additional range such as the addition of range extenders (e.g., repeaters) and/or additional access points to the wireless network, however, such measures often require the purchase of additional specific hardware components. It may therefore be imperative to have a mesh network extender system in place to provide a user with access to a wireless network via their mobile device if the user agrees to allow their mobile device to carry the wireless network signal and act as an extender/repeater device. Thus, embodiments of the present invention may be advantageous to, among other things, allow a user to opt-in to wireless network signal extension via their mobile device (e.g., an IoT device of the user such as their smartphone), identify/receive characteristics associated with a user device, identify attributes (e.g., metadata) associated with a wireless network that would benefit from range extension, determine whether a user device is a candidate for acting as a repeater of a wireless network signal based on identified characteristics of the user device and identified characteristics of the wireless network, grant a device network access in exchange for wireless network signal repetition by the device, dynamically allocate wireless network bandwidth to a device based on information associated with the re-broadcast of a network signal by the device, log information associated with network usage by the device, deny wireless network access by a device upon the device ceasing to repeat a signal of the network, incentivize or compensate a user to allow the re-broadcast of a wireless network signal via their device, maintain a device list for network signal repetition, and increase range and/or strength of a wireless network signal. The present invention does not require that all advantages need to be incorporated into every embodiment of the invention.

According to at least one embodiment, a user wising to access a wireless network (e.g., a guest wireless network for peer-to-peer network extension) via their IoT device (e.g., their smartphone) may opt-in to utilization of a mesh network extender (MNE) program via their IoT device. The MNE program may manage operation of the wireless network. Additionally, the MNE program may receive contextual (e.g., network usage) and technical characteristics of the IoT device as well as identify metadata of the wireless network. Further, the MNE program may determine whether the IoT device is a candidate for use as a signal repeater of the wireless network, and, if so, may allow access to the wireless network by the IoT device in exchange for re-broadcast of the wireless network signal by the IoT device to one or more other devices. Upon cessation of the wireless network signal re-broadcast by the IoT device, the MNE program may deny access to the wireless network by the IoT device.

According to at least one other embodiment, a user wishing to allow their IoT device to serve as a signal repeater for the wireless network may opt-in to utilization of the mesh network extender MNE program via their IoT device. The MNE program may incentivize or compensate the user, according to agreed upon terms, in exchange for allowing their IoT device to serve as a signal repeater for the wireless network. In such an embodiment, the IoT device of the user may or may not consume bandwidth of the wireless network while re-broadcasting the wireless network signal. According to at least one further embodiment, where an opted-in IoT device is not re-broadcasting a wireless network signal, the MNE program may send a prompt to the IoT device to act as a signal repeater of the wireless network.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The following described exemplary embodiments provide a system, method, and program product to allow a device to join an IoT wireless network in need or range extension by utilizing a signal repeater function of the device to re-broadcast a signal of the wireless network in exchange for network access and/or compensation.

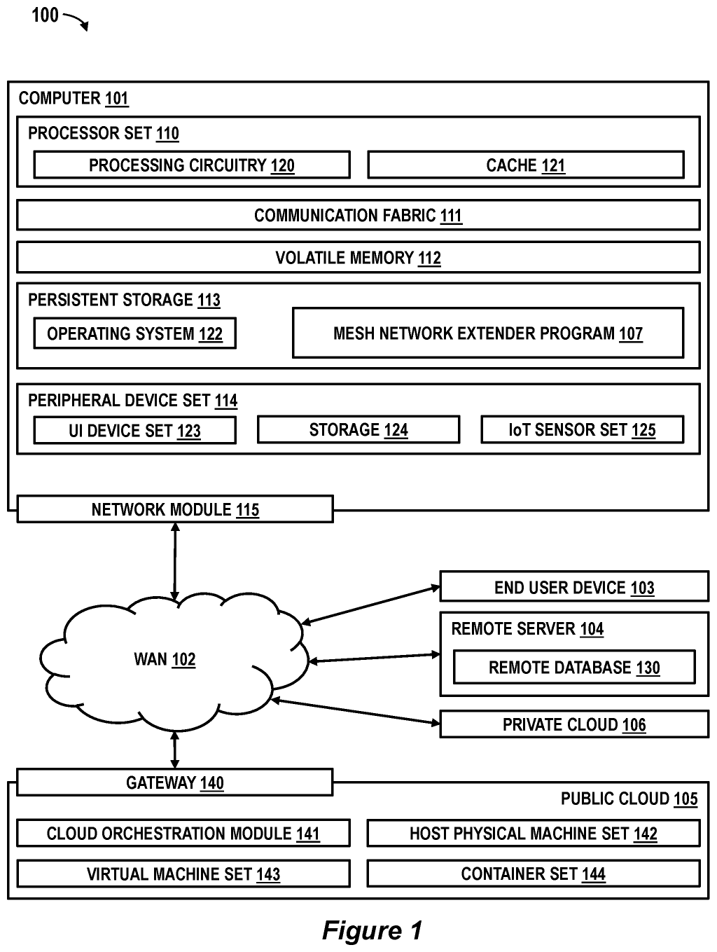

Referring to FIG. 1, an exemplary computing environment 100 is depicted, according to at least one embodiment. Computing environment 100 contains an example of an environment for the execution of at least some of the computer code involved in performing the inventive methods, such as mesh network extender (MNE) program 107. In addition to MNE program 107, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and MNE program 107), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smartphone, smart watch or other wearable computer, mainframe computer, quantum computer or any other form of computer or mobile device now known or to be developed in the future that is capable of running a program and accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in MNE program 107 within persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface type operating systems that employ a kernel. The code included in MNE program 107 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as smart glasses, smart watches, AR/VR-enabled headsets, and wearable cameras), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer, another sensor may be a motion detector, another sensor may be a global positioning system (GPS) receiver, and yet another sensor may be a digital image capture device (e.g., a camera) capable of capturing and transmitting one or more still digital images or a stream of digital images (e.g., digital video).

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network or a mesh network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a client of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on. According to at least one other embodiment, in addition to taking any of the forms discussed above with computer 101, EUD 103 may further be an edge device capable of connecting to computer 101 via WAN 102 and network module 115 and capable of receiving instructions from MNE program 107.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

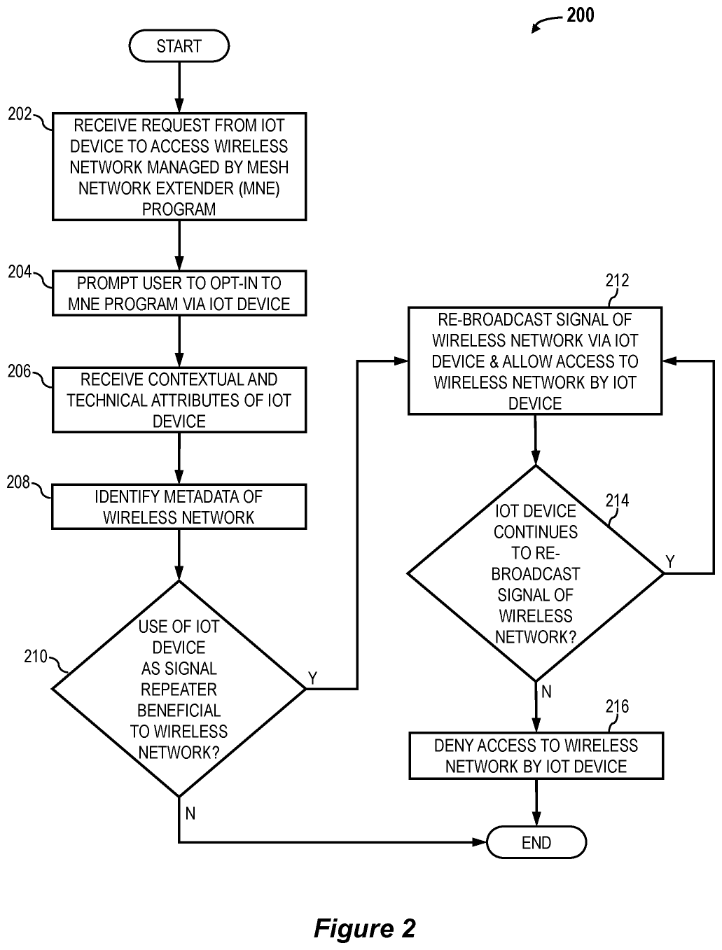

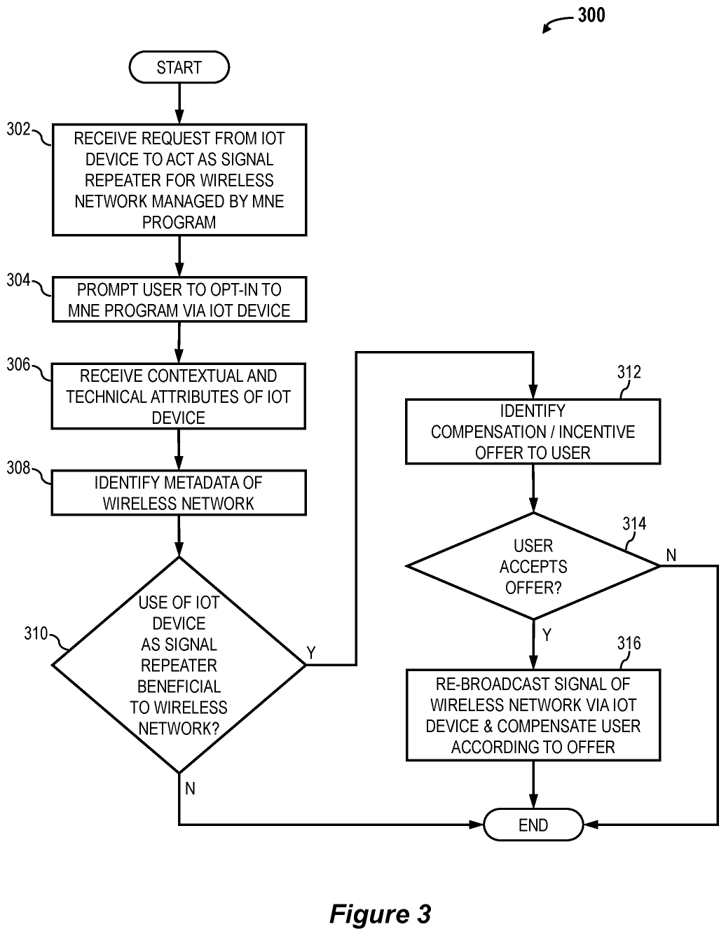

The MNE program 107 may be a program capable of allowing a user to opt-in to wireless network signal extension via their mobile device, managing operation of a wireless network, identifying/receiving technical characteristics associated with a user device, identifying metadata associated with a wireless network, determining/calculating whether a user device is a candidate for acting as a repeater of a wireless network signal based on identified characteristics of the user device and identified characteristics of the wireless network, granting a device network access in exchange for wireless network signal repetition by the device, dynamically allocating wireless network bandwidth to a device based on information associated with the re-broadcast of a network signal by the device, logging information associated with network usage by the device, denying wireless network access by a device upon the device ceasing to repeat a signal of the network, incentivizing or compensating a user to allow the re-broadcast of a wireless network signal via their device, maintaining a device list for wireless network signal repetition, and increasing range and/or strength of a wireless network signal. In at least one embodiment, MNE program 107 may require a user to opt-in to system usage upon opening or installation of MNE program 107, or upon requesting access to a wireless network managed by MNE program 107. Notwithstanding depiction in computer 101, MNE program 107 may be stored in and/or executed by, individually or in any combination, end user device 103, remote server 104, public cloud 105, and private cloud 106 so that functionality may be separated among the devices. The mesh network extender method is explained in further detail below with respect to FIGS. 2 and 3.

Referring now to FIG. 2, an operational flowchart for allowing access, via a mobile device, to a wireless network in exchange for wireless network signal re-broadcast by the mobile device via a mesh network extension access process 200 is depicted according to at least one embodiment. At 202, MNE program 107 receives a request from a user, via their IoT device, to access a wireless network whose operation is managed by MNE program 107. For example, a user seeking internet access may request access, via their smartphone, to an available Wi-Fi network provided by a centralized or decentralized internet service provider and managed by MNE program 107.

Next, at 204, upon receiving a request for access to the wireless network, MNE program 107 prompts the user to opt-in to utilization of MNE program 107 via their IoT device. According to at least one embodiment, as part of the opt-in, MNE program 107 may inform the user, via a display of their IoT device, that bandwidth consumption of the wireless network is conditioned upon the IoT device serving as an extender/repeater device of the wireless network. The user wishing to access the wireless network may accept this condition and opt-in to MNE program 107. According to at least one other embodiment, as part of the opt-in, MNE program 107 may additionally inform the user that access to the wireless by the IoT device, without serving as an extender/repeater device of the wireless network, may be purchased. The user wishing to access the wireless network may purchase access and opt-in to MNE program 107. According to at least one further embodiment, opting-in to utilization of MNE program 107 by the user may set a device opt-in flag of the IoT device to true and may also allow MNE program 107 to send notifications to the IoT device of the user.

At 206, MNE program 107 receives contextual and technical attributes of the opted-in IoT device. According to at least one embodiment, contextual attributes may consist of information regarding current and/or historical network usage by the user via their IoT device and include data such as length(s) of time the IoT device of the user is in the geographic area of a router or an access point of the wireless network and frequency with which the IoT device of the user is within a given radius of the router or access point of the wireless network (e.g., #of times per day, #of days per week). Location data of the IoT device may be sent to MNE program 107 as part of the contextual attributes. Further, MNE program 107 may store, within storage 124 or remote database 130, received contextual attributes of the IoT device and create a repository of historical network usage information of the user. According to at least one embodiment, technical attributes may include information of the opted-in IoT device such as a media access control (MAC) address, an internet protocol (IP) address, a battery power level, received signal strength of the wireless network, and wireless signal re-broadcast capability (e.g., mobile hotspot capability, RF transmit power). Received technical attributes of the IoT device of the user may also be stored within storage 124 or remote database 130 as part of the repository of historical network usage information of the user.

At 208, MNE program 107 identifies metadata associated with the wireless network. According to at least one embodiment, metadata associated with the wireless network may include information such as network type (e.g., Wi-Fi, cellular), router and/or access point location(s), speed and/or strength of wireless network signal at respective router/access point locations, wireless network signal range at respective router/access point locations, number of opted-in IoT devices currently acting as extender/repeater devices of the wireless network signal, as well as their respective contextual and technical attributes, distances between opted-in IoT devices currently acting as extender/repeater devices, and number of opted-in IoT devices currently accessing the wireless network through access purchase (e.g., IoT devices consuming bandwidth of the network but not acting as extender/repeater devices).

Next, at 210, MNE program 107 determines whether use of the opted-in IoT device as an extender/repeater device of the wireless network signal is beneficial to the wireless network. According to at least one embodiment, MNE program 107 may determine that use of the IoT device as an extender/repeater is beneficial to the wireless network where re-broadcast of the wireless network signal by the IoT device results in an increased signal speed, an increased signal strength, and/or a positive range extension of the wireless network. For example, based on the received technical attributes of the opted-in IoT device, MNE program 107 may utilize known methods to calculate a Wi-Fi transmission range of the opted-in IoT device and determine if adding that transmission range capability at the location of the opted-in IoT device results in a positive range extension of the wireless network. Additionally, based on the received contextual and technical attributes of the opted-in IoT device and the identified metadata associated with the wireless network, MNE program 107 may utilize a weighing algorithm to further determine if the IoT device is a candidate for re-broadcasting of the wireless network signal and thus beneficial to the wireless network. For example, if the IoT device of the user has a full battery level (or a battery level above a minimum threshold) and is in an area of the wireless network for an hour each morning, the user's IoT device may be a strong candidate for re-broadcasting the signal of the wireless network. As another example, if the IoT device of the user has a low battery level, has not previously been in the area of the wireless network, and there are already several other devices currently acting as an extender/repeater of the wireless network signal, the user's IoT device may not be a strong candidate for re-broadcasting the signal of the wireless network. A sample weighing algorithm using contextual and technical attributes of the opted-in IoT device to access its viability of improving signal strength and/or range of the wireless network may include a calculation of signal speed+signal strength+current location+historical time in location+battery % remaining+range extender/network signal repeatability features of the device. According to an embodiment, MNE program 107 may predict a future signal strength, speed, and/or range of the wireless network as a result of using the opted-in IoT device as an extender/repeater device.

Moreover, factors of the wireless network such as weakness of received signal by other opted-in IoT devices at locations/areas within the current range of the wireless network, amount of bandwidth consumption by other opted-in IoT devices with low received signal strength, and lack of, or few, other opted-in IoT devices currently acting as an extender/repeater of the wireless network signal in weak signal areas may be indicative of a re-broadcast need of the wireless network and may be considered within the weighing algorithm. For instance, a sample weighing algorithm may include calculation of number of devices with weak received signal strength times factor representing distance or peer strength between those devices plus number of intermediate peer devices between network and cluster of weak signal strength devices times factor representing their contextual and technical attributes.

With continued reference to step 210, in response to determining that use of the opted-in IoT device as an extender/repeater device of the wireless network signal is beneficial to the wireless network (step 210, “Y” branch), the mesh network extension access process 200 may proceed to step 212. In response to determining that use of the opted-in IoT device as an extender/repeater device of the wireless network signal is not beneficial to the wireless network (step 210, “N” branch), the mesh network extension access process 200 may terminate. In the event MNE program 107 determines that use of the opted-in IoT device as an extender/repeater device of the wireless network signal is not beneficial to the wireless network, the user may nevertheless purchase access to the wireless network via their IoT device.

At 212, in response to determining that use of the opted-in IoT device as an extender/repeater device of the wireless network signal is beneficial to the wireless network, MNE program 107 utilizes the wireless signal re-broadcast capability of the opted-in IoT device to extend/repeat the signal of the wireless network to other devices within the network and allows full access to the wireless network via the opted-in IoT device. For example, based on a determined increased signal speed, increased signal strength, and/or positive range extension of the wireless network by using the opted-in IoT device as an extender/repeater device, MNE program 107 allows the user of the opted-in IoT device to access the wireless network as long as they allow their device to act as an extender/repeater within the wireless network. As such, the entire wireless network is strengthened by adding more overall signal speed, signal strength, and/or more Wi-Fi network coverage for other users, especially in remote areas of the network with weak wireless signal. According to at least one embodiment, MNE program 107 may log information relating to the re-broadcast of the wireless network signal by the opted-in IoT device such as, re-broadcast throughput, detected wireless network signal latency, number of other opted-in IoT devices being extended (i.e., accessing the wireless network) via the opted-in IoT device and their respective amounts of bandwidth consumption, geographic location(s) of the opted-in IoT device during re-broadcast and respective time durations at the location(s), and/or time duration of the re-broadcast. Logged information relating to signal re-broadcast may be stored within storage 124 or remote database 130 as part of the contextual attributes of the opted-in IoT device. Furthermore, MNE program 107 may add an identifier of the opted-in IoT device to a list of devices currently providing wireless network signal repetition. According to at least one other embodiment, MNE program 107 may dynamically allocate (e.g., increase or decrease) bandwidth of the wireless network to the opted-in IoT device based on the number of other opted-in IoT devices it is extending. According to at least one further embodiment, MNE program 107 may incentivize the user by allocating increased bandwidth to the opted-in IoT device provided it re-broadcasts the wireless network signal in a specified location of the wireless network and/or for a longer duration of time.

Next, at 214, MNE program 107 determines whether the opted-in IoT device continues to re-broadcast the signal of the wireless network to other opted-in IoT devices. At some point during the re-broadcast of the wireless network signal, the user of the opted-in IoT device may opt-out of MNE program 107, disable the wireless signal re-broadcast capability of the opted-in IoT device, or leave the area of the wireless network. In such events, MNE program 107 may set a device opt-in flag of the opted-in IoT device to false and identify the cessation of wireless signal re-broadcast by the opted-in IoT device. In response to determining that the opted-in IoT device continues to re-broadcast the signal of the wireless network to other opted-in IoT devices (i.e., no identification of signal re-broadcast cessation) (step 214, “Y” branch), the mesh network extension access process 200 may return to step 212 where MNE program 107 continues to utilize the wireless signal re-broadcast capability of the opted-in IoT device and allow access to the wireless network via the opted-in IoT device. In response to determining that the opted-in IoT device no longer continues to re-broadcast the signal of the wireless network (step 214, “N” branch), the mesh network extension access process 200 may proceed to step 216.

At 216, in response to determining that the opted-in IoT device no longer continues to re-broadcast the signal of the wireless network, MNE program 107 denies access to the wireless network by the opted-in IoT device. For example, were the user of the opted-in IoT device disables its wireless signal re-broadcast capability, MNE program 107 may revoke access to the wireless network via the opted-in IoT device. Furthermore, MNE program 107 may remove the identifier of the opted-in IoT device from the list of devices currently providing wireless network signal repetition.

Referring now to FIG. 3, an operational flowchart for compensating a user in exchange for wireless network signal re-broadcast by their mobile device via a mesh network extension compensation process 300 is depicted according to at least one embodiment. At 302, MNE program 107 receives a request from a user, via their IoT device, to act as a signal repeater for a wireless network whose operation is managed by MNE program 107. For example, a user without a need to consume bandwidth of an available Wi-Fi network provided by a centralized or decentralized internet service provider and managed by MNE program 107 may nevertheless request to re-broadcast, via their IoT device, a signal of the Wi-Fi network to other devices, and thereby act as an extender/repeater device of Wi-Fi network, in exchange for compensation.

Next, at 304, upon receiving a request to act as a signal repeater, MNE program 107 prompts the user to opt-in to utilization of MNE program 107 via their IoT device, as largely described above in step 204 of process 200. According to at least one embodiment, as part of the opt-in, MNE program 107 may receive information of one or more financial accounts of the user (e.g., a crypto wallet or other digital payment service) into which currency deposits may be made by MNE program 107. According to at least one other embodiment, during the opt-in, MNE program 107 may also create a network access credit account, associated with the user's IoT device and stored within storage 124 or remote database 130, into which network access credits/tokens may be deposited by MNE program 107. Network access credits/tokens may be used to purchase network access as a bandwidth consumer via an associated IoT device.

At 306, MNE program 107 receives contextual and technical attributes of the opted-in IoT device. At 308, MNE program 107 identifies metadata associated with the wireless network. At 310, MNE program 107 MNE program 107 determines whether use of the opted-in IoT device as an extender/repeater device of the wireless network signal is beneficial to the wireless network. Execution of steps 306, 308, and 310 are similar to the execution of steps 206, 208, and 210, respectively, of process 200 described above. However, based on the outcome of step 310, the mesh network extension compensation process 300 may either terminate or proceed to step 312.

Next, at 312, in response to determining that use of the opted-in IoT device as an extender/repeater device of the wireless network signal is beneficial to the wireless network, MNE program 107 identifies a compensation amount or an incentive to provide to the user in exchange for using the opted-in IoT device as an extender/repeater device of the wireless network. According to at least one embodiment, MNE program 107 may identify a level of re-broadcast need of the wireless network based on evaluation of factors of the wireless network performed at step 310. MNE program 107 may then communicate the identified level of re-broadcast need to the provider of the wireless network and receive a corresponding incentive or compensation rate/amount (i.e., a compensation/incentive offer) for wireless signal re-broadcast. The manner of compensation/incentive offered to the user may include monetary deposits to a financial account of the user, network access credits/tokens deposited to a network access credit account associated with the opted-in IoT device, and/or access (e.g., bandwidth consumption) to the wireless network by the opted-in IoT device. MNE program 107 may present the compensation/incentive offer to the user via a display of the opted-in IoT device.

At 314, MNE program 107 determines whether the user accepts the offer of compensation/incentive identified at step 312. According to at least one embodiment, MNE program 107 may receive an indication of acceptance or rejection of the offer from the user via the opted-in IoT device. According to at least one other embodiment, as part of the opt-in, MNE program 107 may receive, via the opted-in IoT device, user defined parameters which govern interaction between the user of the opted-in IoT device and the offer of compensation/incentive. Such parameters may include a type and an amount of compensation/incentive offered and technical attributes of the opted-in IoT device. For example, where specific parameters such as level of battery power of the opted-in IoT device and/or amount of compensation/incentive are within allowable thresholds, the offer of compensation/incentive may be automatically accepted, and such indication may be automatically sent to MNE program 107. Likewise, where specific parameters are not within allowable thresholds, rejection of the offer of compensation/incentive may be automatically indicated to MNE program 107. In response to determining that the user has accepted the compensation/incentive offer (step 314, “Y” branch), the mesh network extension compensation process 300 may proceed to step 316. In response to determining that the user has not accepted the compensation/incentive offer (step 314, “N” branch), the mesh network extension compensation process 300 may terminate.

At 316, MNE program 107 utilizes the wireless signal re-broadcast capability of the opted-in IoT device to extend/repeat the signal of the wireless network to other devices within the network. Additionally, MNE program 107 compensates the user, according to the accepted compensation/incentive offer, in exchange for using the opted-in IoT device as an extender/repeater device of the wireless network. According to at least one embodiment, MNE program 107 may log information relating to the re-broadcast of the wireless network signal by the opted-in IoT device such as, re-broadcast throughput, detected wireless network signal latency, number of other opted-in IoT devices being extended (i.e., accessing the wireless network) via the opted-in IoT device and their respective amounts of bandwidth consumption, geographic location(s) of the opted-in IoT device during re-broadcast and respective time durations at the location(s), and/or time duration of the re-broadcast. Logged information relating to signal re-broadcast may be stored within storage 124 or remote database 130 as part of the contextual attributes of the opted-in IoT device. Furthermore, MNE program 107 may add an identifier of the opted-in IoT device to a list of devices currently providing wireless network signal repetition. According to at least one other embodiment, MNE program 107 may dynamically allocate (e.g., increase or decrease) bandwidth of the wireless network to the opted-in IoT device based on the number of other opted-in IoT devices it is extending.

It may be appreciated that FIGS. 2 and 3 provide only an illustration of some implementations and do not imply any limitations with regard to how different embodiments may be implemented. Many modifications to the depicted environments may be made based on design and implementation requirements.

According to at least one embodiment, where a user has opt-in to MNE program 107 but is paying for wireless network access via their IoT device (i.e., the device is consuming wireless network bandwidth without acting as an extender/repeater device of the network), MNE program 107 may, based on evaluation of received contextual and technical attributes of the opted-in IoT device and identified metadata associated with the wireless network, prompt the user, via the opted-in IoT device, to act as an extender/repeater device of the wireless network.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, the method comprising:
receiving an opt-in from a user to re-broadcast a signal of a wireless network via an internet-of-things (IoT) device of the user;
receiving contextual and technical attributes of the IoT device;
identifying metadata of the wireless network; and
responsive to determining, based on analysis of the received contextual and technical attributes and the identified metadata, that use of the IoT device to re-broadcast the signal is beneficial to the wireless network, re-broadcasting the signal via the IoT device and granting access to the wireless network via the IoT device.

2. The method of claim 1, further comprising:
responsive to determining that the IoT device has ceased to re-broadcast the signal, denying access to the wireless network via the IoT device.

3. The method of claim 1, further comprising:
dynamically allocating bandwidth of the wireless network to the IoT device based on a number of other IoT devices accessing the wireless network via the re-broadcast of the signal by the IoT device.

4. The method of claim 1, further comprising:
responsive to determining that use of the IoT device to re-broadcast the signal is beneficial to the wireless network, compensating the user for the re-broadcasting, wherein compensating the user comprises at least one of depositing a monetary value into a financial account of the user or depositing network access tokens into a network access credit account associated with the IoT device.

5. The method of claim 1, wherein the contextual attributes of the IoT device comprises information regarding historical use of the wireless network by the IoT device, and wherein the technical attributes of the IoT device comprises a media access control (MAC) address, an internet protocol (IP) address, a battery power level, a received signal strength of the wireless network, and a wireless signal re-broadcast capability.

6. The method of claim 1, wherein metadata of the wireless network comprises a network type, router and/or access point location(s), speed and/or strength of wireless network signal at respective router/access point locations, wireless network signal range at respective router/access point locations, number of other IoT devices currently acting as extender/repeater devices of the wireless network, distances between the other IoT devices currently acting as extender/repeater devices, and number of other IoT devices currently accessing the wireless network through access purchase.

7. The method of claim 1, wherein use of the IoT device to re-broadcast the signal is beneficial to the wireless network where re-broadcast of the signal by the IoT device results in an increased signal speed, an increased signal strength, and/or a positive range extension of the wireless network.

8. A computer system, the computer system comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
receiving an opt-in from a user to re-broadcast a signal of a wireless network via an internet-of-things (IoT) device of the user
receiving contextual and technical attributes of the IoT device;
identifying metadata of the wireless network; and
responsive to determining, based on analysis of the received contextual and technical attributes and the identified metadata, that use of the IoT device to re-broadcast the signal is beneficial to the wireless network, re-broadcasting the signal via the IoT device and granting access to the wireless network via the IoT device.

9. The computer system of claim 8, wherein the method further comprises:
responsive to determining that the IoT device has ceased to re-broadcast the signal, denying access to the wireless network via the IoT device.

10. The computer system of claim 8, wherein the method further comprises:
dynamically allocating bandwidth of the wireless network to the IoT device based on a number of other IoT devices accessing the wireless network via the re-broadcast of the signal by the IoT device.

11. The computer system of claim 8, wherein the method further comprises:
responsive to determining that use of the IoT device to re-broadcast the signal is beneficial to the wireless network, compensating the user for the re-broadcasting, wherein compensating the user comprises at least one of depositing a monetary value into a financial account of the user or depositing network access tokens into a network access credit account associated with the IoT device.

12. The computer system of claim 8, wherein the contextual attributes of the IoT device comprises information regarding historical use of the wireless network by the IoT device, and wherein the technical attributes of the IoT device comprises a media access control (MAC) address, an internet protocol (IP) address, a battery power level, a received signal strength of the wireless network, and a wireless signal re-broadcast capability.

13. The computer system of claim 8, wherein metadata of the wireless network comprises a network type, router and/or access point location(s), speed and/or strength of wireless network signal at respective router/access point locations, wireless network signal range at respective router/access point locations, number of other IoT devices currently acting as extender/repeater devices of the wireless network, distances between the other IoT devices currently acting as extender/repeater devices, and number of other IoT devices currently accessing the wireless network through access purchase.

14. The computer system of claim 8, wherein use of the IoT device to re-broadcast the signal is beneficial to the wireless network where re-broadcast of the signal by the IoT device results in an increased signal speed, an increased signal strength, and/or a positive range extension of the wireless network.

15. A computer program product, the computer program product comprising:
one or more computer-readable tangible storage medium and program instructions stored on at least one of the one or more tangible storage medium, the program instructions executable by a processor capable of performing a method, the method comprising:
receiving an opt-in from a user to re-broadcast a signal of a wireless network via an internet-of-things (IoT) device of the user
receiving contextual and technical attributes of the IoT device;
identifying metadata of the wireless network; and
responsive to determining, based on analysis of the received contextual and technical attributes and the identified metadata, that use of the IoT device to re-broadcast the signal is beneficial to the wireless network, re-broadcasting the signal via the IoT device and granting access to the wireless network via the IoT device.

16. The computer program product of claim 15, wherein the method further comprises:
responsive to determining that the IoT device has ceased to re-broadcast the signal, denying access to the wireless network via the IoT device.

17. The computer program product of claim 15, wherein the method further comprises:
dynamically allocating bandwidth of the wireless network to the IoT device based on a number of other IoT devices accessing the wireless network via the re-broadcast of the signal by the IoT device.

18. The computer program product of claim 15, wherein the method further comprises:
responsive to determining that use of the IoT device to re-broadcast the signal is beneficial to the wireless network, compensating the user for the re-broadcasting, wherein compensating the user comprises at least one of depositing a monetary value into a financial account of the user or depositing network access tokens into a network access credit account associated with the IoT device.

19. The computer program product of claim 15, wherein the contextual attributes of the IoT device comprises information regarding historical use of the wireless network by the IoT device, and wherein the technical attributes of the IoT device comprises a media access control (MAC) address, an internet protocol (IP) address, a battery power level, a received signal strength of the wireless network, and a wireless signal re-broadcast capability, and wherein metadata of the wireless network comprises a network type, router and/or access point location(s), speed and/or strength of wireless network signal at respective router/access point locations, wireless network signal range at respective router/access point locations, number of other IoT devices currently acting as extender/repeater devices of the wireless network, distances between the other IoT devices currently acting as extender/repeater devices, and number of other IoT devices currently accessing the wireless network through access purchase.

20. The computer program product of claim 15, wherein use of the IoT device to re-broadcast the signal is beneficial to the wireless network where re-broadcast of the signal by the IoT device results in an increased signal speed, an increased signal strength, and/or a positive range extension of the wireless network.
